(19) United States
(12) Patent Application Publication
(10) Pub. No.: US 2003/0200122 A1
(43) Pub. Date: Oct. 23, 2003

(54) On-line method of linking agents and customers

(76) Inventors: Peter W. Nauert, Lake Geneva, WI (US); Bruce M. Henry, Aurora, OH (US); Susan M. Hahn, Westerville, OH (US); Thomas S. Maroun, Scottsdale, AZ (US); Gayle M. Vixler, Columbia Station, OH (US); Celeste A. Kloth, Norhfield Center, OH (US); Nancy L. Zalud, Rockford, IL (US); Elizabeth C. Tenner, Lakewood, OH (US); Brian S. Tenner, Lakewood, OH (US); John Kertis, Strongsville, OH (US)

Correspondence Address: Jonathan A. Platt, Renner, Otto, Boisselle & Sklar, LLP, Nineteenth Floor, 1621 Euclid Avenue, Cleveland, OH, 44115-2191, US

(21) Appl. No.: 10/274,100

(22) Filed: Oct. 17, 2002

Related U.S. Application Data
(60) Provisional application No. 60/329,974, filed on Oct. 17, 2001.

(51) Int. Cl. G06F 17/60

(52) U.S. Cl. 705/4

(57) ABSTRACT

A system for providing insurance services on line includes means for assigning an agent to a customer or potential customer. The agent may be assigned by comparing customer information, such as location information, with information regarding various agents.

This application claims the benefit of U.S. Provisional Application No. 60/329,974, filed Oct. 17, 2001.

### TECHNICAL FIELD

The invention is generally related to the field of on-line services, and is particularly related to a system and method for providing on-line insurance services.

### BACKGROUND OF THE RELATED ART

The growth of the Internet (also known as the World Wide Web, or simply the “web”) has spurred tremendous growth in the on-line availability of products and services previously offered only by more traditional channels of commerce, such as in person. The web offers many advantages for consumers seeking to purchase products and services on line: transactions are fast and may be performed in the privacy of one's home or office; transactions may be performed at a time convenient to the consumer, rather than at set business hours; and the web facilitates price comparisons between competing providers. Businesses also reap benefits from providing on-line services. For example, orders may be taken at a variety of times, and processed when convenient. Businesses may be able to avoid the cost and inventory involved in maintaining numerous offices or retail outlets. Tracking of orders may be easier and gathering of information on customers may be facilitated by on-line submission.

However, difficulties in providing on line services may arise for services for which expert knowledge or personal interaction is desired by the customer.

### SUMMARY OF THE INVENTION

A system for providing insurance services on line assigns an agent to a customer. The customer may then contact the agent with questions or concerns that may arise.

According to an aspect of the invention, a method of providing insurance services includes: associating, in a server, customer information with a customer; identifying, in the server, one or more insurance agents, based on the customer information; and associating, in the server, the one or more insurance agents with the customer.

According to another aspect of the invention, a system for providing insurance services includes means, in a server, for associating customer information with a customer; means, in the server, for identifying one or more insurance agents, based on the customer information; and means, in the server, for associating the one or more insurance agents with the customer.

According to yet another aspect of the invention, a system for providing insurance services includes a processor coupled to a local interface; a memory coupled to the local interface; and insurance service logic stored on the memory and executable by the processor. The insurance service logic includes logic to associate customer information with a customer; logic to identify one or more insurance agents, based on the customer information; and logic to associate the one or more insurance agents with the customer.

According to still another aspect of the invention, a method of providing insurance services includes: 1) gathering, in a server, initial information from a customer via an on-line application; 2) telephoning the customer, wherein the telephoning includes: a) verifying with the customer at least some of the initial information; and b) gathering additional information from the customer, wherein the additional information includes medical information; and 3) associating, in the server, one or more insurance agents with the customer, based on the initial information.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings:

FIG. 1 is a block diagram of an insurance services network according to an embodiment of the present invention;

FIG. 2 is a functionality block diagram showing exchanges of information between the components of the insurance services network of FIG. 1;

FIGS. 3-7 are flowcharts of functionality of the processing logic of FIG. 1; and

FIG. 8 is a functionality block diagram of the work flow employed in the agent selection process of the processing logic of FIG. 1.

### DETAILED DESCRIPTION

An insurance services system provides on-line means for taking insurance applications and assigning insurance agents to customers or potential customers. Customer information regarding a customer or potential customer may be used to select and assign an agent from a database of agents. For example, the customer's zip code or other address information may be compared with locations of agents, in order to assign an agent located in the customer's locality. Assigning an agent to a customer allows the customer's needs to be better served, for example by providing a contact to handle questions and other inquiries from the customer. In addition, a relationship may be built between the agent and the customer, increasing the chances of long-term business from the customer, and repeat business from the customer regarding other products.

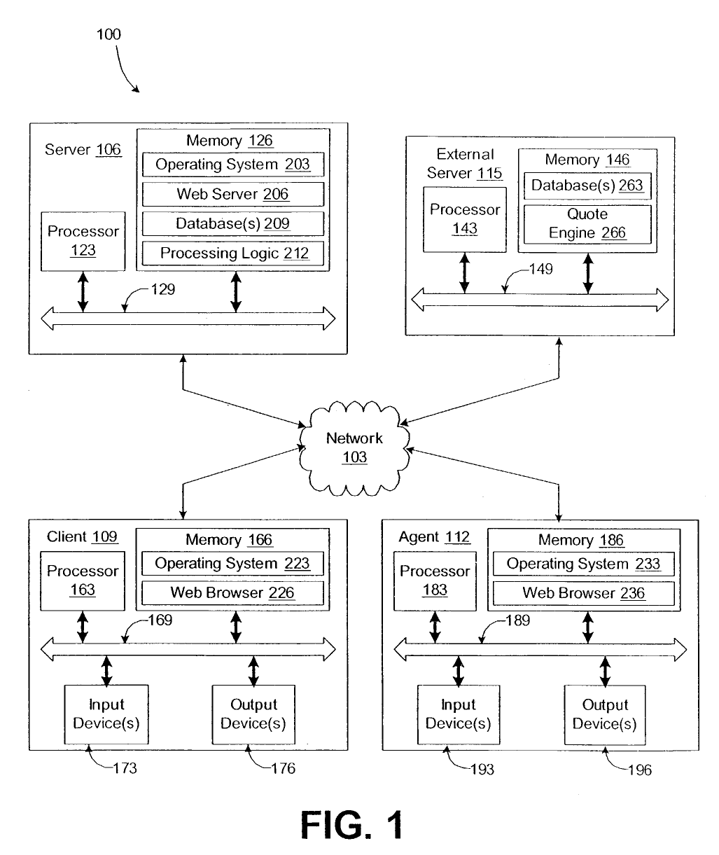

Referring initially to FIG. 1, an insurance services system 100 includes a number of computers coupled together via a network 103. The computers include a server 106, a client computer 109, an agent computer 112, and an external server 115.

The main server 106 may include, for example, a computer system or other apparatus with similar capability. In particular, the main server 106 includes a processor circuit with a processor 123 and a memory 126, both of which are coupled to a local interface 129. The local interface 129 may include, for example, a data bus with an accompanying control bus, as is generally known by those with ordinary skilled in the art. Various peripheral devices may be employed with the main server 106. In particular, peripheral devices to obtain user input may include, for example, a keypad, touch pad, touch screen, microphone, scanner, mouse, joystick, or one or more pushbuttons, etc. Peripheral devices providing user output may include display devices, indicator lights, speakers, printers, etc. Specific display devices may be, for example, cathode ray tubes (CRTs), liquid crystal display screens, gas-plasma-based flat panel displays, light emitting diodes, etc.

The external server 115 includes a processor 143, a memory 146, and a local interface 149. The processor, memory, and local interface, of the external server 115, may be similar to those described above with reference to the main server 106.

The client computer 109 may include, for example, a computer system or other system with similar capabilities. In particular, the client computer 109 includes a processor circuit with a processor 163 and a memory 166, both of which are coupled to a local interface 169. The local interface 169 may be, for example, a data bus with accompanying control bus, as is generally known by those with ordinary skill in the art. The client computer 109 also includes various output interfaces 173 and input interfaces 176 through which the client computer 109 may be connected to various peripheral devices. Such peripheral devices may include a display device, a printer, a keyboard, and a mouse. Other peripheral devices that may be employed with the client computer 109 to receive various user inputs or to provide user output include those listed above with regard to the main server 106.

The client computer 109 (also referred to as herein as a client) is operated by a user (also referred to herein as a customer) in an interactive process with the main server 106, via the network 103, to enable the customer to receive on-line insurance services. For example, the system 100 allows the customer to receive information (presentations) on insurance services, to obtain quotes on insurance policies, and to apply on line for an insurance policy.

The agent computer 112 includes a computer system or other system with similar capability. More particularly, the agent computer 112 includes a processor circuit with a processor 183 and a memory 186. The agent computer 112 also includes a local interface 189, as well as output interfaces 193 and input interfaces 196. The components 183 through 196 of the agent computer 112 may be similar to the corresponding components described above with regard to the client computer 109.

The agent computer 112 functions as an interface between an agent and the main server 106, for example allowing the agent to submit information to the main server 106 and receive messages from the main server 106.

The various memories 126, 146, 166, and 186 may include both volatile and non-volatile memory components. Volatile components are those that do not retain data values upon loss of power. Non-volatile components are those that retain data upon loss of power. Thus, the memories may include, for example, random access memory (RAM), read-only memory (ROM), hard disk drives, floppy disk accessed via an associated floppy disk drive, compact disks accessed by a compact disk drive, magnetic tapes accessed via an appropriate tape drive, other magnetic media, and/or other memory components of a combination of any two or more of these memory components.

In addition, the various processors 123, 143, 163, and 183 may represent multiple processes and the memories 126, 146, 166, and 186, may represent multiple memories that operate in parallel. In such a case, one or more of the local interfaces 129, 149, 169, and 189, may be one or more appropriate networks that facilitates communication between any two of the multiple processors or between any processor and any of the memories, etc. The local interfaces may facilitate memory-to-memory communication as well. The processors, memories and local interfaces may be electrical and/or optical in nature. The memories may be magnetic in nature.

Further, the network 103 may include, for example, the Internet, wide area networks (WANs), local area networks (LANs) and/or other suitable networks, etc., or any combination of two or more such networks. The main server 106, the client computer 109, the agent computer 112, and the external server 115, may be coupled to the network 103 to facilitate data communication to and from the network 103 in any one of a number of ways that are generally known by those of ordinary skill in the art. For example, the various components may be linked to the network 103 through various devices such as, for example, network cards, modems, or other such communication devices.

The main server 106 includes various software components that are stored on the memory 126 and are executable by the processor 123. In particular, an operating system 203, a web server 206, one or more databases 209, and processing logic 212, all may be stored on the memory 126. The web server 206 includes a number of web pages.

The client computer 109 also includes a number of software components that are stored on the memory 166, and are executable by the processor 163. In particular, the client computer 109 includes an operating system 223 and a web browser 226. By manipulating the web browser 226, the pages stored on the main server 106 may be downloaded, having been transmitted by the web server 206 stored on the memory 126 of the main server 106. Thus, the web browser 226 and the web server 206 may operate according to the dictates of the World Wide Web protocol, for example, or according to the dictates of another suitable protocol. In this sense, the pages stored on the main server 106 may be considered web pages, although other types of pages or data files may be employed. In one embodiment, pages may be created using hypertext mark-up language, as is generally known by those with ordinary skill in the art. Alternatively, other programming languages may be employed to create the pages, including JAVA, Active Server Page, Scripting (ASP), JavaScript, C++, or another suitable computer language. Accordingly, the web pages sent from the main server 106 to the client computer 109 may include applets to gather and/or transmit information from the client computer 109 to the main server 106. The term “applet” as used herein, is intended to broadly include programs downloadable to a recipient machine and executable on that machine. An applet, for example, may be written in Java programming language and may be able to run within a browser on a recipient machine.

The agent computer 112 may have stored on its memory 186 an operating system 233 and a web browser 236. The web browser 236 may be used in conjunction with the web server 206 for passing information between the main server 106 and the agent computer 112 via the network 103.

The operating systems 203, 223 and 233, are executed to control allocation and usage of hardware resources in the main server 106, the client computer 109, and the agent computer 112, respectively. Specifically, the operating systems control allocation and usage of the respective memories 126, 166, and 186, processing time, and the peripheral devices as well as performing other functions. In this manner, the operating systems serve as the foundation on which applications in the main server 106, the client computer 109, and the agent computer 112, depend, as is generally known by those with ordinary skill in the art.

In addition, the processor 163 and the client computer 109 may execute the browser 226 to interpret one or more pages downloaded from the main server 106. Based on the pages, the browser 226 generates corresponding graphical user interfaces (GUIs) on a display, for manipulation by the customer or user of the client computer 109.

The external server 115 has, stored on its memory 136, one or more databases 263, and a quote engine 266. As explained in greater detail below, the databases 263 may include information such as application information, presentation information, and/or quote information. As used herein, “application information” refers broadly to information presented to the customer during the on-line application process. Such application information may include questions or templates designed to obtain information from the customer for use in the application process. Examples of such information to be obtained from the customer include the customer's name, age, height, weight, medical history, family history, etc. In addition, application information may include information presented to the customer during the application process.

The term “presentation,” as used herein, broadly indicates general information about a product or service, for example, information about an insurance plan (benefits, terms and conditions, eligibility requirements, rate tables, etc.) Presentations may include text, graphics, charts, video clips, etc. or a combination thereof. Presentation information or presentation data is intended to broadly cover information included in presentations or used to transmit and/or display presentations.

The quote engine 266 may be executable by the processor 143 to provide insurance quotes upon request. The term “quote,” as used herein, broadly indicates price or rate information. In particular, a quote indicates price or rate information which corresponds to one or more characteristics of an individual, for example, age, sex, marital status, health, and/or habits. The quote engine 266 may draw on information from the one or more databases 263, as well as information included with the request. The external server 115 may be a server belonging to a different entity from the owner of the information on the main server 106.

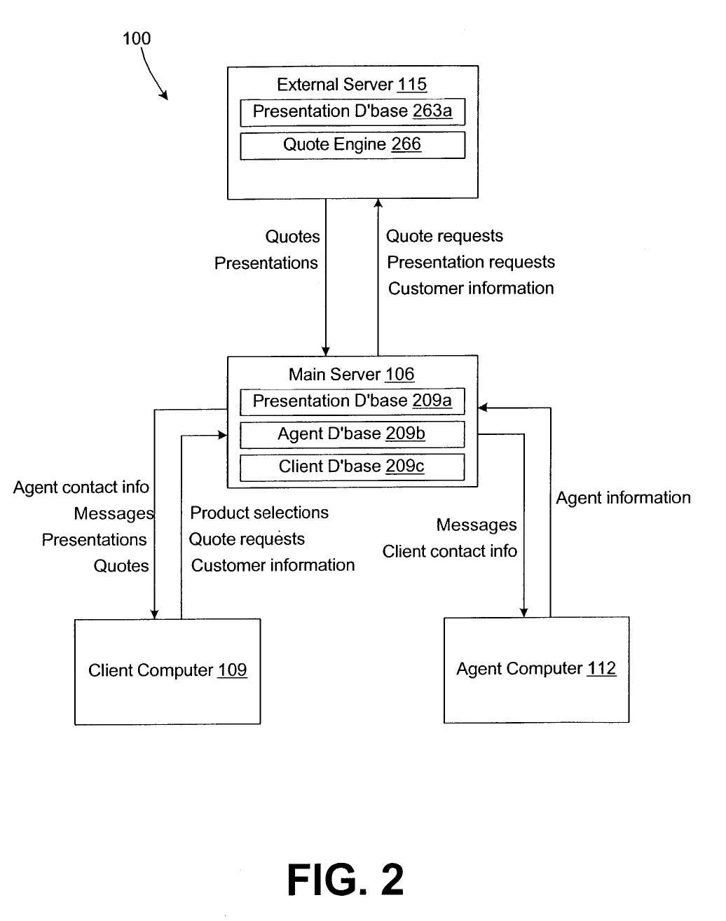

Turning now to FIG. 2, an overview is shown of the data transferred between the main server 106, and the client computer 109, the agent computer 112 and the external server 115. The client computer 109 sends the main server 106 product selections, quote requests, and customer information. The customer information includes various information about the user of client computer 109 (the customer), such as the customer's address, income, assets, health and family history, etc. The main server 106 sends to the customer (via the client computer 109) information such as agent contact information, presentations regarding available insurance products, and quotes for insurance rates for products. The information exchanged between the main server 106 and the client computer 109 may be exchanged in the form of web pages sent from the main server 106 to the client computer 109, and responses to interactive inquiries made as part of the web pages (sending information from the client computer 109 to the main server 106). Alternatively, or in addition, information may be sent between the main server 106 and the client computer 109 by other methods, for example, by electronic mail.

The agent computer 112 may send agent information to the main server 106. The agent information is information about the agent, and may include contact information regarding the agent, such as address, telephone number, electronic mail address, and business hours. The agent information may be submitted on line, for example, by electronic mail or by interaction with suitable web pages stored in the main server 106 and sent to the agent computer 112 and interactively filled out.

Messages and customer contact information may be sent from the main server 106 to the agent computer 112 via the network 103, for example, by electronic mail. Alternatively, or in addition, messages may be sent to the agent by other means, such as via a voice mail message, a telephone call (either personal or performed by an automated caller), by a pager message, etc. Messages from the main server 106 sent to the agent computer 112 may include customer contact information and other information regarding the customer, such as the customer's age, marital status, family size, income, occupation, etc.

The main server 106 may send requests for presentations and/or quotes to the external server 115. Such requests may include customer information, for example, information required in order to process a quote request so as to generate the quote. The external server 115, in turn, may return quotes and presentation data to the main server 106. Such quotes and presentation data may, in turn, be stored and/or forwarded to the client computer 109.

In general terms, the system 100 allows a customer to secure insurance services on line. The client computer 109 interacts with the main server 106 to enable the customer to view presentations regarding various insurance products. The main server 106 may store presentation information in a presentation database 209a. Alternatively, the main server 106 may access presentations from a presentation database 263a in the external server 115. As noted above, the external server 115 may correspond to a different insurance company than the company running the main server 106 contacted by the client computer 109. The customer, via the client computer 109, may then request a quote. The main server 106 may generate the quote itself. Alternatively, the main server 106 may send a quote request to the external server 115, which in turn, generates a quote in its quote engine 266. The quote is then forwarded to the client computer 109. Thereafter, the customer may choose to apply for insurance on line, for example by filling out interactive pages sent by the main server 106, thereby submitting customer information necessary for completion of the application. The application and customer information submitted may be processed in whole or in part on line, for example by the main server 106, or after forwarding to a server corresponding to the insurance company offering the product applied for, for example to the external server 115. Alternatively, some or all of the processing of the application may occur off line.

At any of various points along the process of product selection, presentation viewing, quoting, and application, an agent is assigned to the customer. The customer is provided with contact information for the agent, to enable the customer to contact the agent to follow-up on progress in the process, or to answer any questions or receive assistance regarding the process of obtaining insurance. It will be appreciated that various customers may bring a wide variety of concerns to agents, and thus may obtain assistance from agents in a variety of ways. Further, merely knowing that a specified agent has been assigned to him or her may provide comfort to a customer going through the application process.

The assignment of an agent may occur automatically at a given point in the process. For example, an agent may be assigned when the final application is completed and submitted. As another example, the agent may be assigned when a quote is generated, to allow the customer to have a contact for further information or for questions that may arise prior to the decision to apply for a product. It will be appreciated that the agent may be assigned to the customer at other suitable points in the process.

Alternatively or in addition, the assignment of an agent may be triggered by the customer, for example, upon request of the customer, via a message sent from the client computer 109 to the main server 106.

The agent may be assigned by selecting an agent from an agent database 209b which is maintained in the main server 106. An agent may be assigned based on proximity between the agent and the customer, for example, selecting the agent from the agent database 209b who has a business address which is closest to the address of the customer. It will be appreciated that a large variety of criteria and combinations of criteria may be used in selecting an agent. A few possible criteria for selecting agents are the agent's expertise and the past track record of the agent with similar customers or with customers in general. It will be appreciated that multiple agents may be tentatively selected and presented to the customer, with the customer making a final selection from among the multiple agents.

Once an agent has been assigned to the customer, the agent may be associated with the customer by including agent information or a suitable identifier in a customer database 209c which includes other information regarding the customer. In addition, customer contact information may be sent to the agent computer 112, and agent contact information may be sent to the client computer 109. This allows either the agent or the customer to initiate further contact.

It will be appreciated that the system 100 shown in FIGS. 1 and 2, and described above, is merely one example of a suitable system. It will be appreciated that other suitable configurations are possible. For example, some or all of the functions of the external server 115 may be spread over multiple external computers. Alternatively, all of the functions of the external server 115 may be included in the main server 106. As a further alternative, it will be appreciated that information in the external server 115 may be uploaded into the main server 106 on a periodic basis, for example allowing information from the presentation database 263a to be uploaded weekly into the presentation database 209a maintained by the main server 106. Many alternatives will be evident to those skilled in the art.

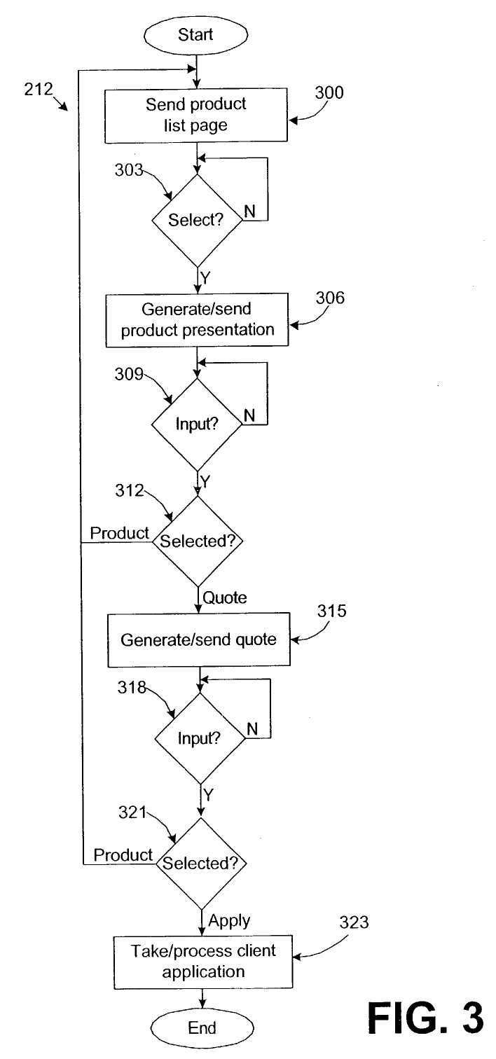

FIG. 3 shows a flowchart of the general functionality (logical functions) of the processing logic 212 (FIG. 1) of the main server 106. Alternatively, the flowchart of FIG. 3 may represent method steps undertaken in executing the processing logic 212. In block 300 the main server 106 sends a product list page to the client computer 109. The product list page includes information about various products such as various types of insurance, which are available to customers. It will be appreciated that the block 300 may involve more than one page and may involve entry by the customer of preliminary data. For example, the products available to the customer may be dependent upon where the customer lives or other circumstances of the customer. For example, renter's insurance is available to only those who rent, rather than to homeowners.

In block 303 the main server 106 waits for the customer to make a selection of a product. Once the selection has been forwarded by the client computer 109 to the main server 106, in block 306 a presentation regarding the selected product is generated and sent to the client computer 109. The presentation may be a more detailed explanation of the selected product. The presentation may be obtained from the presentation database 209a (FIG. 2) of the main server 106. Alternatively, the presentation may be obtained from the presentation database 236a of the external server 115. After the presentation is sent to the client computer 109, in block 309 the main server 106 waits for input from the client computer 109. When the input is received, it is analyzed in block 312 to determine whether the input is a request for information on another product, or is a request for a quote. If the input is a request for information regarding another product, the processing logic 212 reverts to block 300, again sending the product list page. Alternatively, if the customer has requested a quote, the quote is generated and sent in block 315. As discussed above, the quote may be generated in the main server 106. Alternatively, the quote may be generated by sending a request to an external server, such as the external server 115, for generation in the quote engine 266. After the quote is sent the main server 106 awaits further input from the client computer 109, in block 318. When the input is received, in block 321 the input is examined to determine whether the customer desires information on another product or whether the customer wishes to make an on-line application. If information on another product is desired, the processing logic 212 reverts to block 300, sending the product list page. On the other hand, if the customer input is a request to apply for a policy, in block 323 the customer's application is taken and processed.

As suggested by the above discussion, an agent may be assigned to the customer either automatically, or at the request of the customer, as part of any of a number of processes shown in FIG. 3 and described above.

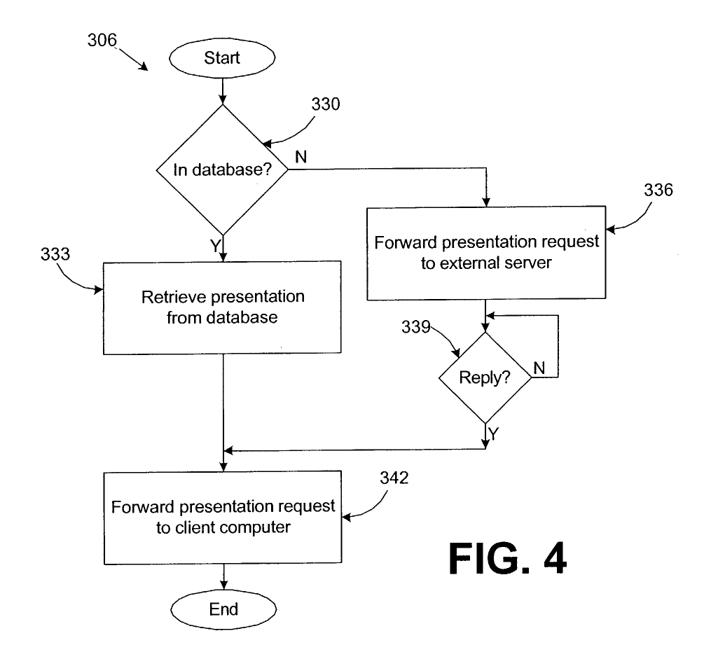

Turning now to FIG. 4, further details are shown of block 306, the generation and sending of product presentations. In block 330 a determination is made in the main server 106 as to whether the requested presentation is in the main server's presentation database 209a. If so, in block 333 the requested presentation is retrieved from the presentation database 209a. If not, in block 336 a presentation request is forwarded to the external server 115. While the external server 115 processes the request and retrieves the requested presentation from the presentation database 263a, the main server 106 awaits a reply in block 339. After the presentation has been retrieved from either the main server 106 or the external server 115, as appropriate, the presentation is forwarded to the client computer 109, in block 342.

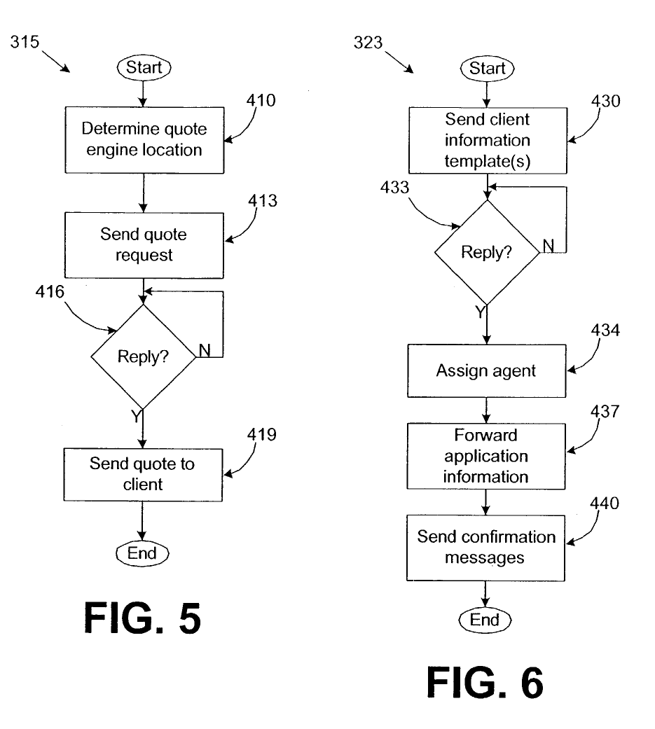

FIG. 5 shows further details are shown in block 315, the generation and sending a quote. In block 410 the location of the appropriate quote engine is determined. As discussed above, an appropriate quote engine may be in the main server 106, or may be in an external server such as the external server 115. Assuming that the appropriate quote engine is external to the main server 106, a quote request is sent from the main server 106 to the external server 115 in block 413. (It will be appreciated that a determination may be made in the main server 106 as to whether the quote request is to be handled by the main server 106 or by the external server 115.) The main server 106 then waits for a reply in block 416. When the reply is received, the quote is sent to the client computer 109, in block 419.

FIG. 6 shows further details of block 323, in which the customer's application is taken and processed. In block 430, pages are sent to the client computer 109 requesting customer information. Block 430 may involve sending and receiving multiple pages. It will be appreciated that the pages may utilize applets, and such well known devices as pick lists, dialogue boxes, and push buttons, to allow the customer to efficiently enter information. For each of the information templates sent, the main server 106 awaits a reply in block 433. After all the replies have been received, an agent is assigned to the customer in block 434. If the application information is to be forwarded, such as to another insurance company, the forwarding is performed in block 437. Finally, one or more confirmation messages are sent in block 440, for example, to the client computer 109 and/or to the agent computer 112. The confirmation messages may be electronic mail messages, or may be a variety of other suitable messages.

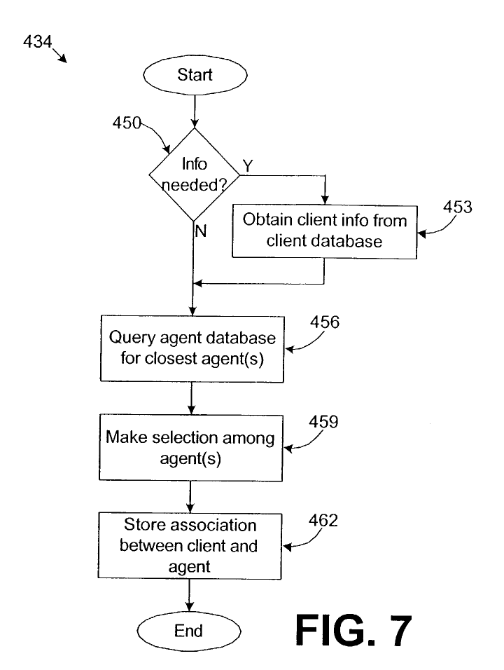

Turning now to FIG. 7, further details are shown of the agent assignment performed in block 434. In block 450, determination is made as to whether further information is needed in order to assign an agent. If further information is needed, in block 453 information is obtained from the customer database 209c. Then in block 456 the agent database 209b is queried to determine the closest agent or agents. For example, a preliminary selection may include all agents with offices in the same zip code as the customer. It will be appreciated that criteria other than location may be used in making a preliminary selection of agents. In block 459 a final selection is made from among the agents preliminarily selected. This final selection may be made by the customer, or may be made by a criterion other than that used in block 456. For example, an initial selection of a group of agents may be made by location, with a final selection being made by expertise in certain areas or number of customers currently handled. It will be appreciated that a wide variety of criteria may be employed to make the initial and/or final selections, and that various criteria may be combined in an infinite variety of logical and/or mathematical combinations. Further, it will be appreciated that a single-step process may be used to select an agent, for example, basing the selection on a single criterion or a one-step combination of multiple criteria. In block 462, the association between the customer and agent is stored, for example being stored in both the agent database 209b and the customer database 209c.

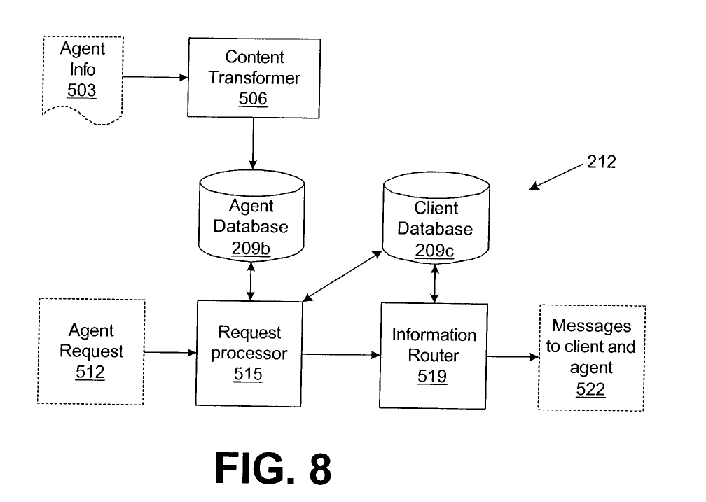

FIG. 8 is a functional block diagram illustrating process flow in the processing logic 212 of the main server 106. Agent information 503 may be received from the agent computer 112, or may be input by an input device either coupled directly to the main server 106, or coupled to an intermediate computer. The agent information 503 is acted upon by a content transformer 506 and is stored in the agent database 209b. When an agent request 512, a request for assignment of an agent, is received by the main server 106, the agent request is acted upon by a request processor 515. The request processor draws any required information from the customer database 209c, and queries the agent database 209b in one or more steps to handle selection of an agent. The selection is then forwarded to an information router 519, which stores the association between the agent and the customer in the customer database 209c, and forwards messages 522 to the customer and agent.

It will be appreciated that the application process described above may involve additional steps of contacting the customer, other than through use of computer systems. For example, the agent may contact the customer to obtain additional information. Alternatively or in addition, a verification telephone call may be placed to the customer to confirm the application and the information included with the application. Further, the telephone call itself may go beyond mere verification of information, and may be used to gather additional information. For instance, the verification telephone call may also be used to gather medical information regarding the customer.

Gathering of medical information via telephone call may result in certain advantages over other ways of gathering medical information, such as the agent gathering the information (either by telephone or in face-to-face meetings with the customer) or by having the customer submit such information in an on-line application. First, the medical information gathered via a verification telephone call may be more complete and more accurate than that gathered by other methods. This increase in completeness and accuracy may be because of a number of reasons, such as 1) increased qualifications of those conducting the information-gathering telephone calls (who may be, for example, nurses or other health-care professionals); 2) increased specialization of those conducting the information-gathering telephone calls (as opposed to agents, for whom information-gathering is only a small part of their jobs, and who may be tasked with gathering different types of information for different companies); and/or 3) the relative anonymity of a one-on-one contact via telephone, which is contrasted on the one hand with the nearly-complete anonymity of on-line questionnaire answering, and on the other hand with the personal relationship involved with direct agent-customer contact, which may cause the customer to withhold potentially embarrassing information.

As another advantage, the gathering of medical information by telephone may increase the overall efficiency of the process. The gathering of information as part of the telephone call, rather than in an on-line application, simplifies the on-line application process. It will be appreciated that requesting great amounts of information as part of an on-line application may lead some customers to become frustrated and impatient, which may lead to unwillingness to make an on-line application. This may be especially true when the information requested is medical information, which may be sensitive for some customers. Such customer frustration and impatience may increase when such information is gathered on line, only to later be verified in a telephone call, causing the customer to provide the information twice. Further, gathering such information first in a telephone call allows customers to ask clarifying questions, thus improving the quality of information gathered.

Gathering the information as part of a follow-up telephone call, rather than involving the agent in the information-gathering process, of course also means less effort on the part of agents, who are then free to concentrate on other business activities.

Although the processing logic 212 of the present invention is embodied in software executed by general purpose hardware discussed above, as an alternative the processing logic 212 may also be embodied in dedicated hardware, or in a combination of software/general purpose hardware and dedicated hardware. If embodied in dedicated hardware, the processing logic 212 may be implemented as a circuit or state machine that employs one of or a combination of a number of technologies. These technologies may include, but are not limited to, discrete logic circuits having logic gates for implementing various logic functions upon an application of one of more data signals, application-specific integrated circuits having appropriate logic gates, programmable gate arrays (PGA), field programmable gate arrays (FPGA), or other components, etc. Such technologies are generally well known by those skilled in the art, and consequently are not described in detail herein.

The flow charts in FIGS. 3-7 show the architecture, functionality, and operation of an implementation of the processing logic 212. If embodied in software, each block may represent a module, segment, or a portion of code that comprises one or more action statements in the form of executable instructions or declarations to implement the specifics of the specified logical function(s). If embodied in hardware, each block may represent a circuit or a number of interconnected circuits to implement the specified logical function or functions. Although the flow charts of FIGS. 3-7 show a specific order of execution, it is understood that the order of execution may differ from that which is depicted. For example, the order of execution of two or more blocks may be scrambled relative to the order shown. Also, two or more blocks shown in succession in FIGS. 3-7 may be executed concurrently or with partial concurrence. It is understood that all such variations are within the scope of the present invention. Also, the flow charts of FIGS. 3-7 are relative self-explanatory and are understood by those with ordinary skilled in the art to the extent that software and/or hardware may be created with one of ordinary skilled in the art to carry out the various logic functions as described herein.

The processing logic 212 may be embodied in any suitable computer-readable medium for use by or in connection with an instruction execution system such as a computer/processor based system or other system that can fetch or obtain the logic from the computer-readable medium and execute the instructions or action statements contained therein. In the context of this document, a “computer-readable medium” may be any suitable medium that can contain, store, or maintain the processing logic 212 for use by or in connection with the instruction execution system. The computer-readable medium may include any one of many physical media, such as, for example, electronic, magnetic, optical, electromagnetic, infrared, or semiconductor media. More specific examples of suitable computer-readable media include, but are not limited to, portable magnetic computer diskettes such as floppy diskettes or hard drives, random access memory (RAM), read-only memory (ROM), erasable-programmable read-only memory, or portable compact disks.

The invention then, is a system and method which allows for automatic assignment of an agent during the on-line presentation/quote/application process. Providing a contact for a customer going through the process allows the customer access to a knowledgeable expert, and allows for building a relationship between the customer and an agent which can result in repeat business and increased retention of customers.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of providing insurance services, comprising:
associating, in a server, customer information with a customer;
identifying, in the server, one or more insurance agents, based on the customer information; and
associating, in the server, the one or more insurance agents with the customer.

2. The method of claim 1, wherein the customer information includes address information, and wherein the identifying includes identifying the one or more insurance agents by their proximity to a location associated with the address information.

3. The method of claim 2, wherein the address information includes a zip code, and the identifying the one or more insurance agents includes selecting the one or more insurance agents by their proximity to the zip code.

4. The method of claim 1, wherein the customer information is part of a quote request.

5. The method of claim 4, further comprising generating a quote using the customer information, and sending the quote to the customer.

6. The method of claim 5, wherein the generating the quote includes forwarding at least some of the customer information to a quote engine.

7. The method of claim 6, wherein the quote engine is an external quote engine that is part of another server which is external to the server.

8. The method of claim 5, wherein the generating the quote is performed in the server.

9. The method of claim 1, wherein the customer information is part of an on-line application.

10. The method of claim 9, further comprising sending an application message to another server which is external of the server, wherein the application message contains application information from the on-line application.

11. The method of claim 1, wherein the associating the one or more insurance agents with the customer includes assigning one of the agents to the customer.

12. The method of claim 11, further comprising sending a message to the assigned agent, wherein the message contains at least some of the customer information.

13. The method of claim 12, wherein the message is an electronic mail message.

14. The method of claim 1, further comprising sending an agent information message to a client, wherein the agent information message includes agent information regarding the one or more agents.

15. The method of claim 14, wherein the agent information message is included in a web page sent to the client.

16. The method of claim 14, wherein the agent information message is included in an electronic mail message sent to the client.

17. The method of claim 1, further comprising:
sending one or more product presentations to a client; and
generating quotes in response to one or more quote requests from the client.

18. The method of claim 17, further comprising taking an on-line application from the customer, utilizing information sent from the client.

19. The method of claim 1, wherein the method is performed by a system which includes:
means, in the server, for associating the customer information with the customer;
means, in the server, for identifying the one or more insurance agents, based on the customer information; and
means, in the server, for associating the one or more insurance agents with the customer.

20. The method of claim 1, wherein the method is performed by a system which includes:
a processor coupled to a local interface;
a memory coupled to the local interface; and
insurance service logic stored on the memory and executable by the processor, the insurance service logic including:
logic to associate customer information with a customer;
logic to identify one or more insurance agents, based on the customer information; and
logic to associate the one or more insurance agents with the customer.

21. A system for providing insurance services, comprising:
means, in a server, for associating customer information with a customer;
means, in the server, for identifying one or more insurance agents, based on the customer information; and
means, in the server, for associating the one or more insurance agents with the customer.

22. The system of claim 21, wherein the customer information includes address information, and wherein the means for identifying includes means for identifying the one or more insurance agents by their proximity to a location associated with the address information.

23. The system of claim 21, wherein the means for associating the one or more insurance agents with the customer includes means for assigning one of the agents to the customer.

24. The method of claim 23, further comprising means for sending a message to the assigned agent, wherein the message contains at least some of the customer information.

25. The system of claim 21, further comprising:
means for sending one or more product presentations to a client; and
means for generating quotes in response to one or more quote requests from the client.

26. The system of claim 25, further comprising means for taking an on-line application from the customer, utilizing information sent from the client.

27. A system for providing insurance services, comprising:
a processor coupled to a local interface;
a memory coupled to the local interface; and
insurance service logic stored on the memory and executable by the processor, the insurance service logic including:
logic to associate customer information with a customer;
logic to identify one or more insurance agents, based on the customer information; and
logic to associate the one or more insurance agents with the customer.

28. The system of claim 27, wherein the customer information includes address information, and wherein the logic to identify includes logic to identify the one or more insurance agents by their proximity to a location associated with the address information.

29. The system of claim 27, wherein the logic to associate the one or more insurance agents with the customer includes logic to assign one of the agents to the customer.

30. The method of claim 29, wherein the insurance service logic further includes logic to send a message to the assigned agent, wherein the message contains at least some of the customer information.

31. The system of claim 27, wherein the insurance service logic further includes:
logic to send one or more product presentations to a client; and
logic to generate quotes in response to one or more quote requests from the client.

32. The system of claim 27, wherein the insurance service logic further includes logic to take an on-line application from the customer, utilizing information sent from the client.

33. A method of providing insurance services, comprising:
gathering, in a server, initial information from a customer via an on-line application;
telephoning the customer, wherein the telephoning includes:
verifying with the customer at least some of the initial information; and
gathering additional information from the customer, wherein the additional information includes medical information; and
associating, in the server, one or more insurance agents with the customer, based on the initial information.
